(19) United States
(12) Patent Application Publication
(10) Pub. No.: US 2025/0321684 A1
(43) Pub. Date: Oct. 16, 2025

(54) TIME MULTIPLEXING AND WEIGHT DUPLICATION IN EFFICIENT IN-MEMORY COMPUTING

(71) Applicant: Rain Neuromorphics Inc., San Francisco, CA (US)

(72) Inventors: Ramyad Hadidi, University Park, MD (US); Mohammed Elneanaei Abdelmoneem Fouda, Alexandria, VA (US)

(21) Appl. No.: 19/033,296

(22) Filed: Jan. 21, 2025

Related U.S. Application Data
(60) Provisional application No. 63/623,650, filed on Jan. 22, 2024.

(51) Int. Cl. G06F 3/06

(52) U.S. Cl. CPC G06F 3/0625; G06F 3/0659; G06F 3/0673

(57) ABSTRACT

A hardware compute-in-memory (CIM) module is described. The CIM hardware module includes storage sites and compute logic. The compute logic is coupled with the storage sites and is configured to perform, in parallel, operations on data stored in the storage sites. The CIM hardware module is configured to store weights in blocks of the storage sites, to utilize the blocks and portions of the compute logic corresponding to the blocks to selectively provide outputs of the operations for the weights stored in the blocks, and to read the outputs of the operations corresponding to the blocks at different times.

### CROSS REFERENCE TO OTHER APPLICATIONS

This application claims priority to U.S. Provisional Patent Application No. 63/623,650 entitled TIME MULTIPLEXING AND WEIGHT DUPLICATION FOR EFFICIENT IN-MEMORY COMPUTING filed Jan. 22, 2024, which is incorporated herein by reference for all purposes.

### BACKGROUND OF THE INVENTION

Artificial intelligence (AI), or machine learning, utilizes learning networks loosely inspired by the brain in order to solve problems. Learning networks typically include layers of weights that weight signals (mimicking synapses) combined with activation layers that apply functions to the signals (mimicking neurons). The weight layers are typically interleaved with the activation layers. In the forward, or inference, path, an input signal is propagated through the learning network. In so doing, a weight layer can be considered to multiply input signals (the “activation” for that weight layer) by the weights stored therein and provide corresponding output signals. For example, the weights may be analog resistances or stored digital values that are multiplied by the input current, voltage or bit signals. The weight layer provides weighted input signals to the next activation layer, if any. Neurons in the activation layer operate on the weighted input signals by applying some activation function (e.g. ReLU or Softmax) and provide output signals corresponding to the statuses of the neurons. The output signals from the activation layer are provided as input signals (i.e. the activation) to the next weight layer, if any. This process may be repeated for the layers of the network, providing output signals that are the resultant of the inference. Learning networks are thus able to reduce complex problems to a set of weights and the applied activation functions. The structure of the network (e.g. the number of and connectivity between layers, the dimensionality of the layers, the type of activation function applied), including the value of the weights, is known as the model.

Although a learning network is capable of solving challenging problems, the computations involved in using such a network are often time consuming. For example, a learning network may use millions of parameters (e.g. weights), which are multiplied by the activations to utilize the learning network. Learning networks can leverage hardware, such as graphics processing units (GPUs) and/or AI accelerators, which perform operations usable in machine learning in parallel. Such tools can improve the speed and efficiency with which data-heavy and other tasks can be accomplished by the learning network. However, efficiency of such tools may still be less than desired. For example, some layers of weights may only require storage in a portion of a memory hardware accelerator. As a result, the utilization of the memory and associated electronics may be less than desired. This may adversely affect performance of the hardware accelerator not only because of the low utilization, but also because pipelining and other techniques may be adversely affected. Consequently, improvements are desired.

### BRIEF DESCRIPTION OF THE DRAWINGS

Various embodiments of the invention are disclosed in the following detailed description and the accompanying drawings.

FIGS. 1A-1B depict an embodiment of a portion of a compute engine usable in an accelerator for a learning network and a compute tile with which the compute engine may be used.

FIG. 2 depicts an embodiment of a portion of a compute engine usable in an accelerator for a learning network and capable of performing local updates.

FIG. 3 depicts an embodiment of a portion of a compute-in-memory module usable in an accelerator for a learning network.

FIG. 4 depicts an embodiment of a portion of a compute-in-memory module usable in an accelerator for a learning network.

FIG. 5 depicts an embodiment of a compute-in-memory module usable in an accelerator for a learning network for which time multiplexing may be used.

FIG. 6 depicts an embodiment of a compute-in-memory module usable in an accelerator for a learning network for which time multiplexing may be used.

FIG. 7 is a flow chart depicting an embodiment of a method for using a CIM hardware module for performing operations using time multiplexing.

FIG. 8 is a flow chart depicting an embodiment of a method for using a CIM hardware module for performing operations using time multiplexing.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A hardware compute-in-memory (CIM) module is described. The CIM hardware module includes storage sites and compute logic. The compute logic is coupled with the storage sites and is configured to perform, in parallel, operations on data stored in the storage sites. The CIM hardware module is configured to store weights in blocks of the storage sites, to utilize the blocks and portions of the compute logic corresponding to the blocks to selectively provide outputs of the operations for the weights stored in the blocks, and to read the outputs of the operations corresponding to the blocks at different times. The operations may be vector-matrix multiplication operations.

In some embodiments, to utilize the blocks and the portions of the compute logic and wherein the CIM hardware module is configured to route an input to a portion of the compute logic for a block of the blocks. The CIM module may read an output of the corresponding block. The CIM hardware module may include a demultiplexer and a multiplexer. The demultiplexer is configured for routing the input to the portion of the compute logic for the block while the multiplexer is configured to select the output corresponding to the block.

In some embodiments, the blocks include a first block and a second block. The weights of the first block may be replicated in the weights of the second block. The hardware CIM may be configured to store the weights in the blocks based on an optimization of throughput and utilization of the CIM hardware module. The blocks may include a first block and a second block that share a portion of the compute logic. A first output of the operations on the first block is output at a first time, while a second output of the operations for the second block is output at a second time.

The compute logic may include a first set of logic gates corresponding to the first block, a second set of logic gates corresponding to the second block, and adders coupled to the first plurality of logic gates and the second plurality of logic gates, the adders providing a first output at the first time and the second output at the second time. In some embodiments, the second block is not powered on during the first time and the first block is not powered on during the second time.

A compute tile including compute engines and a general-purpose (GP) processor is described. Each of the compute engines includes a hardware compute-in-memory (CIM) module. The CIM hardware module includes storage sites and compute logic coupled with the storage sites. The compute logic is configured to perform, in parallel, operations on data stored in the storage sites. The GP processor is coupled with the plurality of compute engines and configured to provide control instructions and/or data to the compute engines. The CIM hardware module is configured to store weights in blocks of the storage sites, to utilize the blocks and portions of the compute logic corresponding to the blocks to selectively provide outputs of the operations for the weights stored in the blocks, and to read the outputs of the operations corresponding to the blocks at different times. The operations may be vector-matrix multiplication operations.

In some embodiments, the CIM hardware module further includes a demultiplexer and a multiplexer. The demultiplexer routes an input to a portion of the compute logic corresponding to a block of the blocks. The multiplexer is configured to select an output corresponding to the block. The hardware CIM may store the weights in the blocks based on an optimization of throughput and utilization of the CIM hardware module.

In some embodiments, the blocks include a first block and a second block. The first block and the second block share a portion of the compute logic. A first output of the operations on the first block are output at a first time, while a second output of the operations for the second block is output at a second time. The compute logic includes a first plurality of logic gates corresponding to the first block, a second plurality of logic gates corresponding to the second block, and adders coupled to the first plurality of logic gates and the second plurality of logic gates. The adders provide a first output at the first time and the second output at the second time.

A method is described. The method includes performing, in parallel, a first plurality of operations on a first set of weights stored in a first block of a plurality of blocks of storage sites of a hardware compute-in-memory (CIM) module. The CIM hardware module includes compute logic coupled with the storage sites. The compute logic is configured to selectively perform in parallel, operations for the blocks and provide outputs for the operations. The operations include the first plurality of operations. The method also includes reading, from the CIM hardware module, a first output for the first plurality of operations corresponding to the first block at a first time. A second plurality of operations is performed, in parallel, on a second set of weights stored in a second block of the plurality of blocks. The operations include the second plurality of operations. A second output for the second plurality of operations corresponding to the second block is read from the CIM hardware module at a second time.

In some embodiments, the method includes storing, in the first block and the second block, the first set of weights and the second set of weights. In some such embodiments, the storing includes storing of the first and second sets of weights in the first and second blocks based on an optimization of throughput and utilization of the CIM hardware module. In some embodiments, performing the first plurality of operations in parallel further includes routing a first input to a first portion of the compute logic for the first block. Reading the first output further includes using a multiplexer to select the first output corresponding to the first block. Similarly, performing in parallel the second plurality of operations further includes routing a second input to a second portion of the compute logic for the second block; and wherein the reading the second output further includes using a multiplexer to select the second output corresponding to the second block.

The method and system are described in the context of particular features. For example, certain embodiments may highlight particular features. However, the features described herein may be combined in manners not explicitly described. Although described in the context of particular CIM hardware modules, storage cells, and logic, other components may be used. For example, although particular embodiments utilize digital SRAM storage cells, other storage cells, including but not limited to analog storage cells (e.g. resistive storage cells) may be used. Similarly, although described in the context of weights and activations, other input vectors (or matrices) and other tensors may be used in conjunction with the methods and systems described herein.

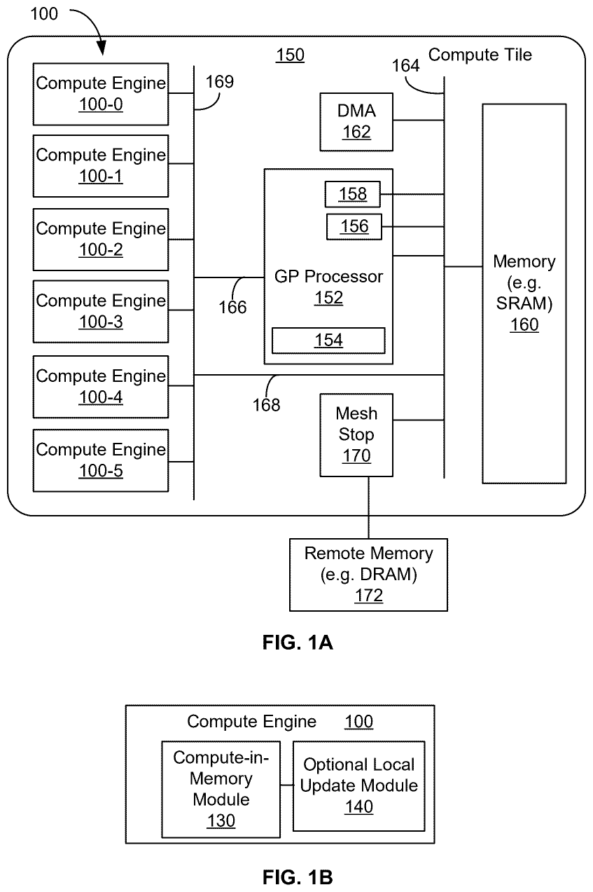

FIGS. 1A-1B depict an embodiment of a portion of compute engine 100 usable in an accelerator for a learning network and compute tile 150 (i.e. an embodiment of the environment) in which the compute engine may be used. FIG. 1A depicts compute tile 150 in which compute engine 100 may be used. FIG. 1B depicts compute engine 100. Compute engine 100 may be part of an AI accelerator that can be deployed for using a model (not explicitly depicted) and, in some embodiments, for allowing for on-chip training of the model (otherwise known as on-chip learning). Referring to FIG. 1A, system 150 is a compute tile and may be considered to be an artificial intelligence (AI) accelerator having an efficient architecture. Compute tile (or simply “tile”) 150 may be implemented as a single integrated circuit. Compute tile 150 includes a general purpose (GP) processor 110 and compute engines 100-0 through 100-5 (collectively or generically compute engines 100) which are analogous to compute engine 100 depicted in FIG. 1A. Also shown are on-tile memory 160 (which may be an SRAM memory) direct memory access (DMA) unit 162, and mesh stop 170. Thus, compute tile 150 may access remote memory 172, which may be DRAM. Remote memory 172 may be used for long term storage. In some embodiments, compute tile 150 may have another configuration. Further, additional or other components may be included on compute tile 150 or some components shown may be omitted. For example, although six compute engines 100 are shown, in other embodiments another number may be included. Similarly, although on-tile memory 160 is shown, in other embodiments, memory 160 may be omitted. GP processor 152 is shown as being coupled with compute engines 100 via compute bus (or other connector) 169 and bus 166. Compute engines 100 are also coupled to bus 164 via bus 168. In other embodiments, GP processor 152 may be connected with compute engines 100 in another manner.

In some embodiments, GP processor 152 is a reduced instruction set computer (RISC) processor. For example, GP processor 152 may be a RISC-V processor or ARM processor. In other embodiments, different and/or additional general purpose processor(s) may be used. The GP processor 152 provides control instructions and, in some embodiments, data to the compute engines 100. GP processor 152 may thus function as part of a control plane for (i.e. providing commands) and is part of the data path for compute engines 100 and tile 150. GP processor 152 may also perform other functions. GP processor 152 may apply activation function(s) to data. For example, an activation function (e.g. a ReLu, Tan h, and/or SoftMax) may be applied to the output of compute engine(s) 100. Thus, GP processor 152 may perform nonlinear operations. GP processor 152 may also perform linear functions and/or other operations. However, GP processor 152 is still desired to have reduced functionality as compared to, for example, a graphics processing unit (GPU) or central processing unit (CPU) of a computer system with which tile 150 might be used.

In some embodiments, GP processor includes an additional fixed function compute block (FFCB) 154 and local memories 156 and 158. In some embodiments, FFCB 154 may be a single instruction multiple data arithmetic logic unit (SIMD ALU). In some embodiments, FFCB 154 may be configured in another manner. FFCB 154 may be a close-coupled fixed-function unit for on-device inference and training of learning networks. In some embodiments, FFCB 154 executes nonlinear operations, number format conversion and/or dynamic scaling. In some embodiments, other and/or additional operations may be performed by FFCB 154. FFCB 154 may be coupled with the data path for the vector processing unit of GP processor 1310. In some embodiments, local memory 156 stores instructions while local memory 158 stores data. GP processor 152 may include other components, such as vector registers, that are not shown for simplicity.

Memory 160 may be or include a static random access memory (SRAM) and/or some other type of memory. Memory 160 may store activations (e.g. input vectors provided to compute tile 150 and the resultant of activation functions applied to the output of compute engines 100). Memory 160 may also store weights. For example, memory 160 may contain a backup copy of the weights or different weights if the weights stored in compute engines 100 are desired to be changed. In some embodiments, memory 160 is organized into banks of cells (e.g. banks of SRAM cells). In such embodiments, specific banks of memory 160 may service specific one(s) of compute engines 100. In other embodiments, banks of memory 160 may service any compute engine 100.

Mesh stop 172 provides an interface between compute tile 150 and the fabric of a mesh network that includes compute tile 150. Thus, mesh stop 172 may be used to communicate with remote DRAM 190. Mesh stop 172 may also be used to communicate with other compute tiles (not shown) with which compute tile 150 may be used. For example, a network on a chip may include multiple compute tiles 150, a GPU or other management processor, and/or other systems which are desired to operate together.

Compute engines 100 are configured to perform, efficiently and in parallel, tasks that may be part of using (e.g. performing inferences) and/or training (e.g. performing inferences and/or updating weights) a model. Compute engines 100 are coupled with and receive commands and, in at least some embodiments, data from GP processor 152. Compute engines 100 are modules which perform vector-matrix multiplications (VMMs) in parallel. Thus, compute engines 100 may perform linear operations. Each compute engine 100 includes a compute-in-memory (CIM) hardware module (shown in FIG. 1A). The CIM hardware module stores weights corresponding to a matrix and is configured to perform a VMM in parallel for the matrix. Compute engines 100 may also include local update (LU) module(s) (shown in FIG. 1A). Such LU module(s) allow compute engines 100 to update weights stored in the CIM. In some embodiments, such LU module(s) may be omitted.

Referring to FIG. 1B, compute engine 100 includes CIM hardware module 130 and optional LU module 140. Although one CIM hardware module 130 and one LU module 140 is shown, a compute engine may include another number of CIM hardware modules 130 and/or another number of LU modules 140. For example, a compute engine might include three CIM hardware modules 130 and one LU module 140, one CIM hardware module 130 and two LU modules 140, or two CIM hardware modules 130 and two LU modules 140.

CIM hardware module 130 is a hardware module that stores data and performs operations. In some embodiments, CIM hardware module 130 stores weights for the model. CIM hardware module 130 also performs operations using the weights. More specifically, CIM hardware module 130 performs vector-matrix multiplications, where the vector may be an input vector provided and the matrix may be weights (i.e. data/parameters) stored by CIM hardware module 130. Thus, CIM hardware module 130 may be considered to include a memory (e.g. that stores the weights) and compute hardware, or compute logic, (e.g. that performs in parallel the vector-matrix multiplication of the stored weights). In some embodiments, the vector may be a matrix (i.e. an n×m vector where n>1 and m>1). For example, CIM hardware module 130 may include an analog static random access memory (SRAM) having multiple SRAM cells and configured to provide output(s) (e.g. voltage(s)) corresponding to the data (weight/parameter) stored in each cell of the SRAM multiplied by a corresponding element of the input vector. In some embodiments CIM hardware module 130 may include a digital static SRAM having multiple SRAM cells and configured to provide output(s) corresponding to the data (weight/parameter) stored in each cell of the digital SRAM multiplied by a corresponding element of the input vector. hardware voltage(s) corresponding to the impedance of each cell multiplied by the corresponding element of the input vector. Other configurations of CIM hardware module 230 are possible. Each CIM hardware module 130 thus stores weights corresponding to a matrix in its cells and is configured to perform a vector-matrix multiplication of the matrix with an input vector.

In order to facilitate on-chip learning, LU module 140 may be provided. LU module 140 is coupled with the corresponding CIM hardware module 130. LU module 140 is used to update the weights (or other data) stored in CIM hardware module 130. LU module 140 is considered local because LU module 140 is in proximity with CIM module 130. For example, LU module 140 may reside on the same integrated circuit as CIM hardware module 130. In some embodiments LU module 140 for a particular compute engine resides in the same integrated circuit as the CIM hardware module 130. In some embodiments, LU module 140 is considered local because it is fabricated on the same substrate (e.g. the same silicon wafer) as the corresponding CIM hardware module 130. In some embodiments, LU module 140 is also used in determining the weight updates. In other embodiments, a separate component may calculate the weight updates. For example, in addition to or in lieu of LU module 140, the weight updates may be determined by a GP processor, in software by other processor(s) not part of compute engine 100 and/or the corresponding AI accelerator, by other hardware that is part of compute engine 100 and/or the corresponding AI accelerator, by other hardware outside of compute engine 100 or the corresponding AI accelerator.

Using compute engine 100 efficiency and performance of a learning network may be improved. Use of CIM hardware modules 130 may dramatically reduce the time to perform the vector-matrix multiplication that provides the weighted signal. Thus, performing inference(s) using compute engine 100 may require less time and power. This may improve efficiency of training and use of the model. LU modules 140 allow for local updates to the weights in CIM hardware modules 130. This may reduce the data movement that may otherwise be required for weight updates. Consequently, the time taken for training may be greatly reduced. In some embodiments, the time taken for a weight update using LU modules 140 may be an order of magnitude less (i.e. require one-tenth the time) than if updates are not performed locally. Efficiency and performance of a learning network provided using system 100 may be increased.

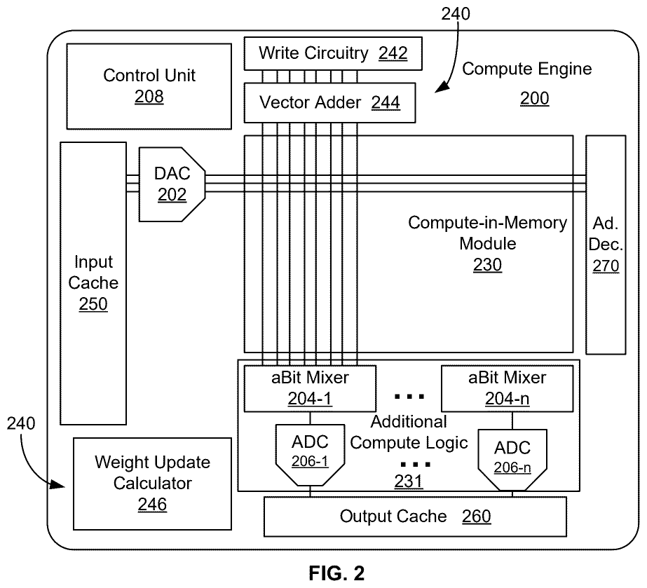

FIG. 2 depicts an embodiment of compute engine 200 usable in an AI accelerator and that may be capable of performing local updates. Compute engine 200 may be a hardware compute engine analogous to compute engine 100. Compute engine 200 thus includes CIM hardware module 230 and optional LU module 240 analogous to CIM hardware modules 130 and LU modules 140, respectively. Compute engine 200 includes input cache 250, output cache 260, and address decoder 270. Additional compute logic 231 is also shown. In some embodiments, additional compute logic 231 includes analog bit mixer (aBit mixer) 204-1 through 204-n (generically or collectively 204), and analog to digital converter(s) (ADC(s)) 206-1 through 206-n (generically or collectively 206). However, for a fully digital CIM hardware module 230, additional compute logic 231 may include logic such as adder trees and accumulators. In some embodiments, such logic may simply be included as part of CIM hardware module 230. In some embodiments, therefore, the output of CIM hardware module 230 may be provided to output cache 260. Although particular numbers of components 202, 204, 206, 230, 231, 240, 242, 244, 246, 260, and 270 are shown, another number of one or more components 202, 204, 206, 230, 231, 240, 242, 244, 246, 160, and 270 may be present. Further, in some embodiments, particular components may be omitted or replaced. For example, DAC 202, analog bit mixer 204, and ADC 206 may be present only for analog weights.

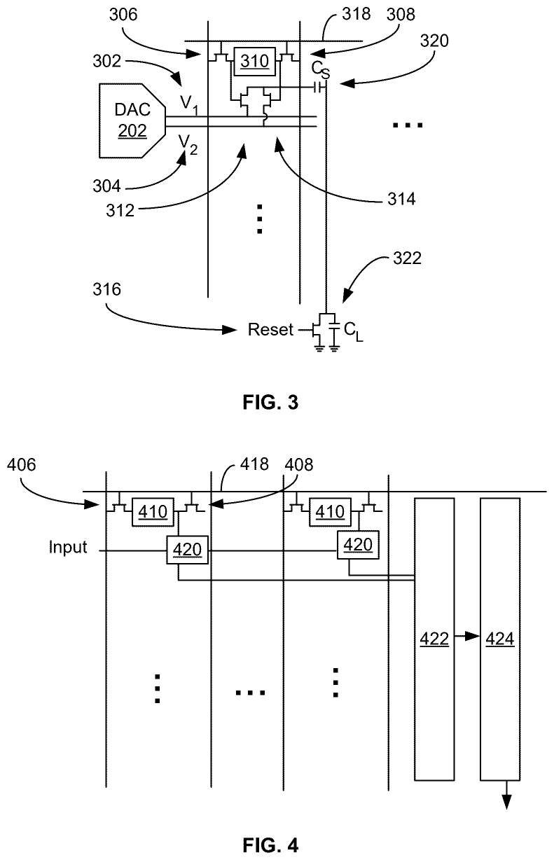

CIM hardware module 230 is a hardware module that stores data corresponding to weights and performs vector-matrix multiplications. The vector is an input vector provided to CIM hardware module 230 (e.g. via input cache 250) and the matrix includes the weights stored by CIM hardware module 230. In some embodiments, the vector may be a matrix. Examples of embodiments CIM modules that may be used in CIM hardware module 230 are depicted in FIGS. 3 and 4.

FIG. 3 depicts an embodiment of a cell in one embodiment of an SRAM CIM module usable for CIM hardware module 230. Also shown is DAC 202 of compute engine 200. For clarity, only one SRAM cell 310 is shown. However, multiple SRAM cells 310 may be present. For example, multiple SRAM cells 310 may be arranged in a rectangular array. An SRAM cell 310 may store a weight or a part of the weight. The CIM hardware module shown includes lines 302, 304, and 318, transistors 306, 308, 312, 314, and 316, capacitors 320 (Cs) and 322 (CL). In the embodiment shown in FIG. 3, DAC 202 converts a digital input voltage to differential voltages, V₁ and V₂, with zero reference. These voltages are coupled to each cell within the row. DAC 202 is thus used to temporal code differentially. Lines 302 and 304 carry voltages V₁ and V₂, respectively, from DAC 202. Line 318 is coupled with address decoder 270 (not shown in FIG. 3) and used to select cell 310 (and, in the embodiment shown, the entire row including cell 310), via transistors 306 and 308.

In operation, voltages of capacitors 320 and 322 are set to zero, for example via Reset provided to transistor 316. DAC 202 provides the differential voltages on lines 302 and 304, and the address decoder (not shown in FIG. 3) selects the row of cell 310 via line 318. Transistor 312 passes input voltage V₁ if SRAM cell 310 stores a logical 1, while transistor 314 passes input voltage V₂ if SRAM cell 310 stores a zero. Consequently, capacitor 320 is provided with the appropriate voltage based on the contents of SRAM cell 310. Capacitor 320 is in series with capacitor 322. Thus, capacitors 320 and 322 act as capacitive voltage divider. Each row in the column of SRAM cell 310 contributes to the total voltage corresponding to the voltage passed, the capacitance, Cs, of capacitor 320, and the capacitance, CL, of capacitor 322. Each row contributes a corresponding voltage to the capacitor 322. The output voltage is measured across capacitor 322. In some embodiments, this voltage is passed to the corresponding aBit mixer 204 for the column. In some embodiments, capacitors 320 and 322 may be replaced by transistors to act as resistors, creating a resistive voltage divider instead of the capacitive voltage divider. Thus, using the configuration depicted in FIG. 3, CIM hardware module 230 may perform a vector-matrix multiplication using data stored in SRAM cells 310.

FIG. 4 depicts an embodiment of a cell in one embodiment of a digital SRAM module usable for CIM hardware module 230. For clarity, only one digital SRAM cell 410 is labeled. However, multiple cells 410 are present and may be arranged in a rectangular array. Also labeled are corresponding transistors 406 and 408 for each cell, line 418, logic gates 420, adder tree 422 and accumulator 424.

In operation, a row including digital SRAM cell 410 is enabled by address decoder 270 (not shown in FIG. 4) using line 418. Transistors 406 and 408 are enabled, allowing the data stored in digital SRAM cell 410 to be provided to logic gates 420. Logic gates 420 combine the data stored in digital SRAM cell 410 with the input vector. Thus, the binary weights stored in digital SRAM cells 410 are combined with (e.g. multiplied by) the binary inputs. Thus, the multiplication performed may be a bit serial multiplication. The output of logic gates 420 are added using adder tree 422 and combined by accumulator 424. Thus, using the configuration depicted in FIG. 4, CIM hardware module 230 may perform a vector-matrix multiplication using data stored in digital SRAM cells 410.

Referring back to FIG. 2, CIM hardware module 230 thus stores weights corresponding to a matrix in its cells and is configured to perform a vector-matrix multiplication of the matrix with an input vector. In some embodiments, compute engine 200 stores positive weights in CIM hardware module 230. However, the use of both positive and negative weights may be desired for some models and/or some applications. In such cases, the sign may be accounted for by a sign bit or other mapping of the sign to CIM hardware module 230.

Input cache 250 receives an input vector for which a vector-matrix multiplication is desired to be performed. The input vector may be read from a memory, from a cache or register in the processor, or obtained in another manner. For analog cells, such as depicted in FIG. 3, digital-to-analog converter (DAC) 202 may convert a digital input vector to analog in order for CIM hardware module 230 to operate on the vector. Although shown as connected to only some portions of CIM hardware module 230, DAC 202 may be connected to all of the cells of CIM hardware module 230. Alternatively, multiple DACs 202 may be used to connect to all cells of CIM hardware module 230. Address decoder 270 includes address circuitry configured to selectively couple vector adder 244 and write circuitry 242 with each cell of CIM hardware module 230. Address decoder 270 selects the cells in CIM hardware module 230. For example, address decoder 270 may select individual cells, rows, or columns to be updated, undergo a vector-matrix multiplication, or output the results. In some embodiments, aBit mixer 204 combines the results from CIM hardware module 230. Use of aBit mixer 204 may save on ADCs 206 and allows access to analog output voltages. ADC(s) 206 convert the analog resultant of the vector-matrix multiplication to digital form. Output cache 260 receives the result of the vector-matrix multiplication and outputs the result from compute engine 200. Thus, a vector-matrix multiplication may be performed using CIM hardware module 230 and cells 310.

For a digital SRAM CIM module, input cache 250 may serialize an input vector. The input vector is provided to CIM hardware module 230. As previously indicated, DAC 202 may be omitted for a digital CIM hardware module 230, for example which uses digital SRAM storage cells 410. Logic gates 420 combine (e.g., multiply) the bits from the input vector with the bits stored in SRAM cells 410. The output is provided to adder trees 422 and to accumulator 424. In some embodiments, therefore, adder trees 422 and accumulator 424 may be considered to be part of CIM hardware module 230. The resultant is provided to output cache 260. Thus, a digital vector-matrix multiplication may be performed in parallel using CIM hardware module 230.

LU module 240 includes write circuitry 242 and vector adder 244. In some embodiments, LU module 240 includes weight update calculator 246. In other embodiments, weight update calculator 246 may be a separate component and/or may not reside within compute engine 200. Weigh update calculator 246 is used to determine how to update to the weights stored in CIM hardware module 230. In some embodiments, the updates are determined sequentially based upon target outputs for the learning system of which compute engine 200 is a part. In some embodiments, the weight update provided may be sign-based (e.g. increments for a positive sign in the gradient of the loss function and decrements for a negative sign in the gradient of the loss function). In some embodiments, the weight update may be ternary (e.g. increments for a positive sign in the gradient of the loss function, decrements for a negative sign in the gradient of the loss function, and leaves the weight unchanged for a zero gradient of the loss function). Other types of weight updates may be possible. In some embodiments, weight update calculator 246 provides an update signal indicating how each weight is to be updated. The weight stored in a cell of CIM hardware module 230 is sensed and is increased, decreased, or left unchanged based on the update signal. In particular, the weight update may be provided to vector adder 244, which also reads the weight of a cell in CIM hardware module 230. More specifically, adder 244 is configured to be selectively coupled with each cell of CIM hardware module by address decoder 270. Vector adder 244 receives a weight update and adds the weight update with a weight for each cell. Thus, the sum of the weight update and the weight is determined. The resulting sum (i.e. the updated weight) is provided to write circuitry 242. Write circuitry 242 is coupled with vector adder 244 and the cells of CIM hardware module 230. Write circuitry 242 writes the sum of the weight and the weight update to each cell. In some embodiments, LU module 240 further includes a local batched weight update calculator (not shown in FIG. 2) coupled with vector adder 244. Such a batched weight update calculator is configured to determine the weight update.

Compute engine 200 may also include control unit 208. Control unit 208 generates the control signals depending on the operation mode of compute engine 200. Control unit 240 is configured to provide control signals to CIM hardware module 230 and LU module 1549. Some of the control signals correspond to an inference mode. Some of the control signals correspond to a training, or weight update mode. In some embodiments, the mode is controlled by a control processor (not shown in FIG. 2, but analogous to processor 110) that generates control signals based on the Instruction Set Architecture (ISA).

Using compute engine 200, efficiency and performance of a learning network may be improved. CIM hardware module 230 may dramatically reduce the time to perform the vector-matrix multiplication. Thus, performing inference(s) using compute engine 200 may require less time and power. This may improve efficiency of training and use of the model. LU module 240 may perform local updates to the weights stored in the cells of CIM hardware module 230. This may reduce the data movement that may otherwise be required for weight updates. Consequently, the time taken for training may be dramatically reduced. Efficiency and performance of a learning network provided using compute engine 200 may be increased.

CIM hardware module 230 may further improve operation of compute engines 100 and/or 200 and compute tile 150. For some models, a smaller number of weights may be desired to be stored in CIM hardware module 230. The number of storage cells in a CIM hardware module 230 may greatly exceed the number of cells required to store the weights for a layer (i.e. a matrix for which a VMM is desired) or portion of a layer to be stored. Thus, only some storage cells of the CIM hardware module store weights for a particular layer (or layers) of a model. The remaining storage cells in the CIM module may be left empty. In such a case, the existing hardware may be used to perform the VMM. However, leaving the remaining storage cells may significantly decrease utilization of the CIM hardware module. As a result, area on the integrated circuit may be wasted. Some existing techniques store weights for other layer(s) in portions of a CIM hardware module along a diagonal. For example, columns 0 through 32 and rows zero through 32 of an array of storage cells may store the weights for one layer (i.e., one matrix), while columns 33 through 128 and rows 33 through 128 may store weights for another layer (i.e., another matrix). Thus, weights for only one layer are stored in each row and each column. The remaining storage cells remain empty (e.g. store zeroes). This configuration is used because in some embodiments, each row processes the same input and each column contributes to the resultant of the VMM. In such techniques the input vector may be packed to include the vector corresponding to each layer (i.e. each portion of the CIM hardware module that stores weights). Again, existing hardware may be used to perform the VMM and utilization is increased. However, utilization of the CIM hardware module may still be significantly less than desired. Consequently, improvements in utilization may still be desired. Such improvements may be achieved using CIM hardware module 200 and time multiplexing.

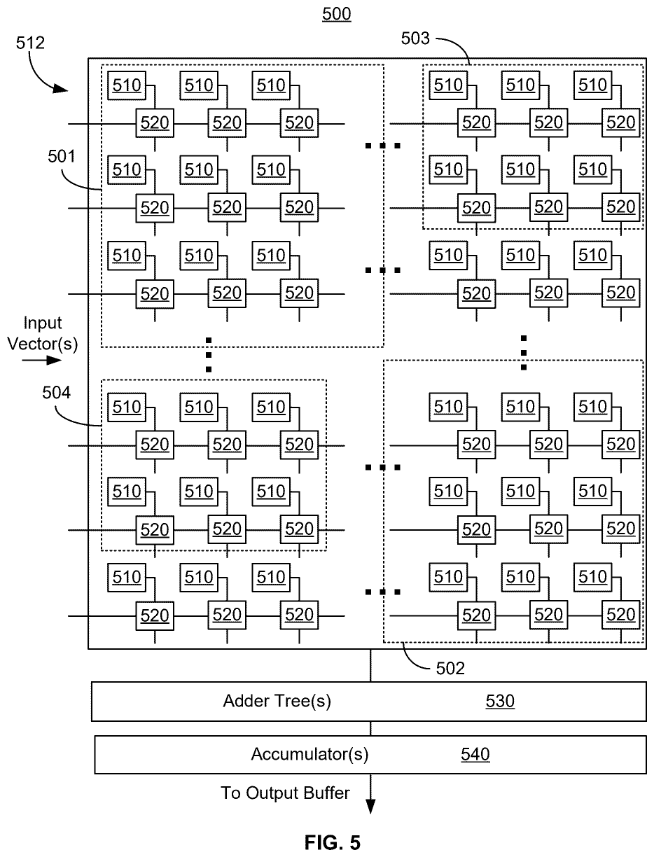

Time multiplexing used in conjunction with a CIM hardware module may be understood in the context of FIG. 5. Time multiplexing includes performing VMMs and providing the output for the VMMs for different portions of a CIM hardware module at different times. FIG. 5 depicts an embodiment of CIM hardware module 500 for which time multiplexing may be used. CIM hardware module 500 may be analogous to CIM hardware modules 130 and 200. CIM hardware module 500 includes storage cells 510 and compute logic. Storage cells 510 may be considered to be organized into array 512. Compute logic includes logic gates 520, adder tree(s) 530, and accumulator 540. Logic gates 520 are coupled with storage cells 510 and perform a bit wise multiplication of the data in the corresponding storage cell 510 and the input vector. Logic gates 520 may be considered part of array 512. Although shown separately from array 512 and connected via a single line, adder tree(s) 530 and accumulator 540 are connected with logic gates 520 in array 512 to perform a VMM. Storage cells 510 in array 512 may share at least a portion (e.g. adder trees 530 and accumulator(s) 540) of compute logic 520, 530, and 540. Thus, in some drawings, adder tree(s) 530 and accumulator 540 are not shown separately and may be considered to be part of array 512. Further, each row (or portion thereof in a block) processes the same input and each column (or portion thereof in a block) contributes to the resultant. Although described in the context of digital CIM module, nothing prevents the use of analog modules, for example storage of weights in resistive cells or other analogous cells.

Weight matrices 501, 502, 503, and 504 are indicated by dashed regions. Each storage cell 510 within weight matrices 501, 502, 503, and 504 stores a bit for a weight in the weight matrix 501, 502, 503, and 504. Although weights for four matrices 501, 502, 503, and 504 are indicated as being stored in array 512, another number of matrices may be stored in some embodiments. Weight matrices 501, 502, 503, and 504 may correspond to different layers. For example, each weight matrix 501, 502, 503 and 504 may include weights for a different layer (i.e. weights for four layers are stored in array 512). In some embodiments, weights may be duplicated. For example, weight matrix 502 may be a duplicate of weight matrix 501, while weight matrix 503 differs from weight matrix 504 (i.e. weights for three layers are stored in array 512). Stated differently, the same data is stored in storage cells 510 for weight matrix 502 as is stored in corresponding storage cells 510 of weight matrix 501. Similarly, weight matrix 504 may be a duplicate of weight matrix 503, while weight matrix 501 differs from weight matrix 504 (i.e. weights for three layers are stored in array 512). In some embodiments, weight matrix 502 may be a duplicate of weight matrix 501 and weight matrix 504 may be a duplicate of weight matrix 503 (i.e. weights for two layers are stored in array 512). Although duplicates are shown in a single array 512 of a particular CIM hardware module 500, in some embodiments, duplicates are desired to be stored in different arrays of different CIM hardware modules and, in some cases, different compute engines. Duplication of some or all of the weights, particularly in different CIM hardware modules, may be used to improve throughput or pipelining of the model.

CIM hardware module 500 is configured such that the weights can be stored throughout array 512, but such that different blocks of storage cells 510 in array 512 may be used for performing a VMM and the output for different blocks read at different times. Stated differently, CIM hardware module 500 is configured to be used with time multiplexing. For example, storage cells 510 for matrix 501 may be multiplied by the desired input vector and the output read at one time (e.g. one time interval, or set of clock cycles), while storage cells 510 for matrix 503 are multiplied by the desired input vector and the output read at another time. In some embodiments, operations on each of matrices 501, 502, 503, and 504 may be processed at different times (i.e. over different interval(s) and/or clock cycle(s)). For example, VMMs for weights stored in storage cells 510 of matrix 501 may be performed and the corresponding output read at one time, VMMs for weights stored in storage cells 510 of matrix 502 may be performed and the corresponding output read at a second time, VMMs for weights stored in storage cells 510 of matrix 503 may be performed and the corresponding output read at a third time, and VMMs for weights stored in storage cells 510 of matrix 504 may be performed and the corresponding output read at fourth time. In some embodiments, VMMs may be performed for matrices 501 and 502 and the output read at one time (i.e. one time interval and/or clock cycle(s)), while VMMs may be performed for matrices 503 and 504 and the output read at another time (i.e. another time interval and/or clock cycle(s)). In order to do so, CIM hardware module 500 may be configured such that blocks corresponding to matrices 501, 502, 503, and 504 may be activated at different times. Activation may include providing power to the blocks for which output is to be read and/or having the input bypass (or provide zeroes to) blocks for which output is not to be read.

For example, suppose that VMMs are to be performed for matrices 501 and 502 at one time (e.g. over a first time interval or first set of clock cycles), and matrices 503 and 504 at another time (e.g. over a second time interval or second set of clock cycles). In such a case, the input vector(s) for matrices 501 and 502 are provided to CIM hardware module 500. Storage cells 510 for matrices 501 and 502 and corresponding portions of the compute logic are activated. In some embodiments, power is provided to portions of array 512 (e.g. logic gates 520) corresponding to matrices 501 and 502. Logic gates 520 for matrices 501 and 502 receive the portion of the input vector and the weight stored in corresponding storage cells 520. Logic gates 520 for matrices 501 and 502 also perform a bit wise multiplication and output the results. In contrast, portions of array 512 corresponding to matrices 503 and 504 are not activated. In some embodiments, power may not be provided to the corresponding compute logic (e.g. logic gates 520 and/or portions of adder tree(s) 530 and accumulator(s)). In some embodiments, the input is not provided to logic gates 520 corresponding to matrices 503 and 504. For example, logic gates 520 for matrices 503 and 504 may receive a zero or otherwise be bypassed by the corresponding portion of the input vector. Consequently, weights stored in storage cells 510 of matrices 503 and 504 do not contribute to the VMMs. Adder tree(s) 530 and accumulator(s) 540 complete the VMMs for matrices 501 and 502. The VMMs for matrices 501 and 502 are performed and the corresponding output of accumulator(s) 540 selected to be output, or read. Thus, the VMMs for weights stored in storage cells 510 for matrices 501 and 502 have been performed.

The VMMs for matrices 503 and 504 are then performed. A new input vector corresponding to matrices 503 and 504 is provided. Logic gates 520 for matrices 503 and 504 receive the portion of the input vector and the weight stored in corresponding storage cells 520. Logic gates 520 for matrices 503 and 504 also perform a bit wise multiplication and output the result. In contrast, portions of array 512 corresponding to matrices 501 and 502 are not activated. In some embodiments, power may not be provided to the corresponding compute logic (e.g. logic gates 520 and/or portions of adder tree(s) 530 and accumulator(s) for matrices 501 and 502). In some embodiments, the input is not provided to logic gates 520 corresponding to matrices 501 and 502. For example, logic gates 520 for matrices 501 and 502 may receive a zero or otherwise be bypassed by the corresponding portion of the input vector. The weights stored in storage cells 510 of matrices 501 and 502 do not contribute to the VMMs. The VMMs for matrices 503 and 504 are performed and the corresponding output of accumulator(s) 540 selected to be output. Thus, the VMMs for weights stored in storage cells 510 for matrices 503 and 504 have been performed. Using time multiplexing, therefore, VMMs may be performed for different portions of array 512 of CIM hardware module 500.

CIM hardware module 500 has improved utilization over a CIM hardware module that stores only one of matrices 501, 502, 503, and 504 or which only stores matrices on a diagonal (i.e. matrices do not share rows or columns). Moreover, latency and throughput may be improved over a CIM hardware module which only stores matrices on a diagonal. For example, if matrices are only allowed to be stored on a diagonal of array 512, then the weights for matrices 501 and 502 may be loaded, VMMs performed, and the results for matrices 501 and 502 output (or read). The matrices 503 and 504 may then be loaded, another set of VMMs performed and the results for matrices 503 and 504 output. Each time another VMM is performed, the weights for the corresponding matrices (or layers) are reloaded. This may require a significant amount of time, particularly if the weights for a matrix are stored off tile. In contrast, for time multiplexing using CIM hardware module 500 the weights for all matrices 501, 502, 503, and 504 may be loaded. The weights for matrices 501, 502, 503, and 504 may then be stationary (i.e. not be reloaded) for a long period of time. For each set of VMMs, the input vector is loaded, the VMMs performed and the output read. The (generally small) cost of performing the time division multiplexing is also incurred. However, the time taken for each set of VMMs may be reduced. Thus, utilization may be improved without significantly sacrificing latency or throughput.

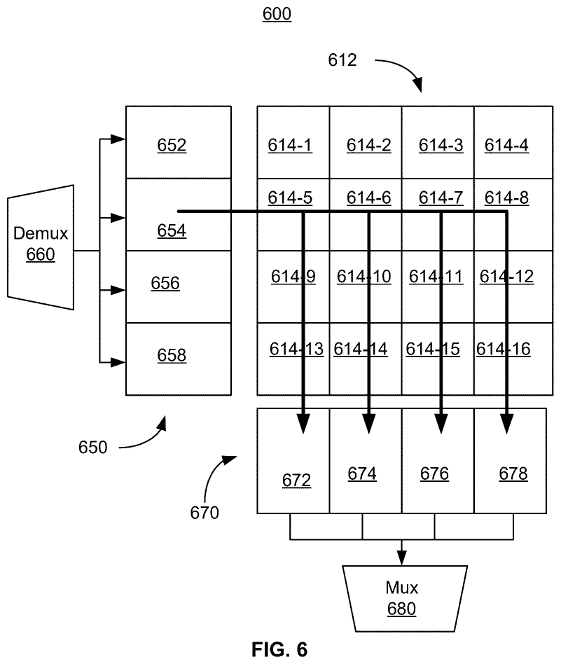

FIG. 6 depicts an embodiment of CIM hardware module 600 usable in an accelerator for a learning network for which time multiplexing may be used. For clarity, only come portions of CIM hardware module 600 are shown. CIM hardware module 600 is analogous to CIM hardware modules 130, 200, and/or 500. CIM hardware module 600 includes array 612 analogous to array 512. Thus, storage cells and logic gates analogous to storage cells 510 and logic gates 512 may be incorporated into array 612. Adder trees (not shown) and accumulators (not shown) that are analogous to adder trees 530 and accumulators 540 are also present. Such adders and accumulators may be part of array 612 in some embodiments. Array 612 has been divided into blocks 614-1, 614-2, 614-3, 614-4, 614-5, 614-6, 614-7, 614-8, 614-9, 614-10, 614-11, 614-12, 614-13, 614-14, 614-15, and 614-16 (collectively or generically block(s) 614). Each block 614 corresponds to a certain number of rows and columns of array 612. Also shown are input buffer 650, demultiplexer 660, output buffer 670, and multiplexer 680. Input buffer is divided into blocks 652, 654, 656, and 658. Each block 652, 654, 656, and 658 corresponds to a certain number of rows (i.e., a row of blocks 614). Output buffer has been divided into blocks 672, 674, 676, and 678. Each block 672, 674, 676, and 678 corresponds to a certain number of columns (i.e. a column of blocks 614). Demultiplexer 660 is used to select to which blocks 652, 654, 656, or 658 an input vector is provided for use with VMMs using array 612. Similarly, multiplexer 680 selects which of blocks 672, 674, 676, and 678 provides output to be read. Although not shown, circuitry may be present to selectively activate one or more blocks 614. Although a particular number of blocks are shown in input buffer 650, array 612, and output buffer 670, another number may be pre sent.

Weights for matrices may be stored in blocks 614. For example, one matrix may be stored in blocks 614-1, 614-2, 614-5, and 614-6, another matrix may be store in blocks 614-3 and 614-4, a third matrix may be stored in block 614-9, another matrix may be stored in blocks 614-10, 614-11, 614-12, 614-14, 614-15, and 614-16, and a last matrix stored in 614-13. In some cases, not all storage cells of a block being used store data.

Weights for one or more matrices are stored in storage cells of selected blocks 614 of array 612. Demultiplexer 660 provides the input vector(s) to appropriate ones of blocks 652, 654, 656, and/or 658. Blocks 652, 654, 656, and 658 provide the input vector to the corresponding rows of array 612. For example, block 654 provides the input vector to the rows of blocks 614-5, 614-6, 614-7, and 614-8. VMM(s) are performed for the matrix or matrices corresponding to the vector(s) by activating the corresponding blocks 614. The resultant is provided to output buffer 670. The output from desired column(s) of array 612 is selected by multiplexer 680 choosing appropriate block(s) of output buffer 670. In the example above, if the matrix desired to undergo a VMM includes block 614-6, multiplexer 680 selects block 674 to be output. The output may be provided by multiplexer 680 to a GP processor for an activation function, to another compute tile, to a memory, or to another component. Input buffer 650 and output buffer 670 may be cleared after each set of VMMs.

Time multiplexing may be employed for CIM hardware module 600, For example, suppose VMMs are to be performed for weights for a first matrix stored in blocks 614-1 and 614-2, a second matrix stored in block 614-7, and a third matrix stored in blocks 614-11, 614-12, 614-15, and 614-16. Suppose also that operations for the first and third matrix are performed at one time interval, and the operations for the second matrix performed at a second time interval. In such a case, the input vector for the first and third matrix are provided by demultiplexer 660 to blocks 652 and blocks 656 and 658. The appropriate blocks 614 for the first and third matrix are activated. The resultant of the VMM for the first matrix are provided from blocks 614-1 and 614-2 to blocks 672 and 674 of output buffer 670. The resultant of the VMM for the third matrix is provided from blocks 614-11, 614-12, 614-15, and 614-16 to blocks 676 and 678. Thus, multiplexer 680 selects all blocks 672, 674, 676, and 678 to output. For example, a GP processor may read the output of all blocks 672, 674, 676, and 678. The input buffer 650 and output buffer 670 are cleared. For the second matrix, demultiplexer 660 provides the input vector to block 654. Block 614-7 for the second matrix is activated and the VMM for the second matrix is performed. The output is provided to block 676 of output buffer 670. Thus, demultiplexer 680 selects the contents of block 676 to be output, or read.

CIM hardware module 600 may thus share the benefits of CIM hardware modules 130, 200, and/or 500. Through the use of time multiplexing, CIM hardware module 600 has improved utilization over a CIM hardware module that stores only one matrix or which only stores matrices on a diagonal (i.e. matrices do not share rows or columns). Moreover, latency and throughput may be improved over a CIM hardware module which only stores matrices on a diagonal. Further, when used in conjunction with other CIM hardware modules (not shown) that may be in other compute engines, CIM hardware module may provide improved throughput and latency, for example by duplicating weights. Thus, performance of a compute engine, compute tile, and/or hardware accelerator incorporating CIM hardware module 600 may be improved.

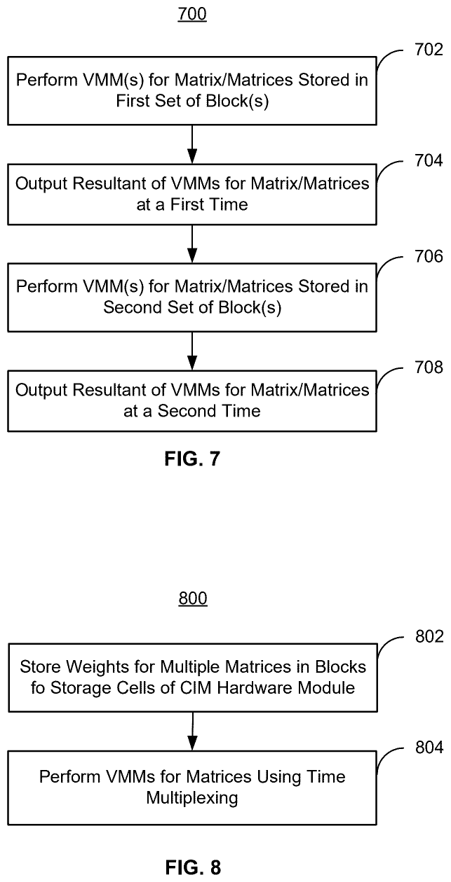

FIG. 7 is a flow chart depicting an embodiment of a method for using a CIM hardware module for performing operations using time multiplexing. Method 700 is described in the context of CIM hardware module 600. However, method 700 is usable with CIM hardware modules 130, 200, and/or 500 and other compute engines and/or compute tiles. Although particular processes are shown in an order, the processes may be performed in another order, including in parallel. Further, processes may have substeps.

A first set of operations is performed on a first set of weights stored in a first set of block(s) of storage sites of a CIM hardware module, at 702. The first set of weights is part of one or more matrices. Thus, VMM(s) for the matrix or matrices stored in the blocks may be performed. The resultant of the VMMs is output at 704. For example, an output buffer may be read or the output sent to a particular component. At 706, the operations are performed for a second set of weights stored in a second set of blocks of storage sites of the CIM hardware module. The blocks for which operations are performed at 706 are different from the blocks for which operations are performed at 702. Thus, VMM(s) for the matrix or matrices stored in the second set of blocks may be performed. The resultant of the VMMs for the second set of blocks is output, at 708. In some embodiments, 702 and 704, or 702 through 708 may be repeated for multiple VMMs of the stored weights.

For example, in CIM hardware module 600, the first set of blocks may include blocks 614-1, 614-2, 614-5, and 614-6 for a first matrix and blocks 614-11, 614-12, 614-15, and 614-16 for a second matrix. The second set of blocks may include blocks 614-4, 614-4, 614-7, and 614-8 for a third matrix and blocks 614-9, 614-10, 614-13, and 614-14 for a fourth matrix. At 702, demultiplexer selects blocks 652, 654, 656 and 658 to be loaded with and provide the input vector for the VMM for the first and second matrices. Also at 702, blocks 614 corresponding to the first and second matrices are activated and the VMM performed. At 704, blocks 672 and 674 are selected by multiplexer 680 to provide the output for the first matrix. Also at 704, multiplexer 680 selects blocks 676 and 678 to output the resultant of the VMM for the second matrix. Input buffer 650 and, in some embodiments, output buffer 670 may be cleared. At 706, demultiplexer selects blocks 652, 654, 656 and 658 to be loaded with and provide the input vector for the VMM for the third and fourth matrices. Also at 706, blocks 614 corresponding to the third and fourth matrices are activated and the VMM performed. At 708, blocks 672 and 674 are selected by multiplexer 680 to provide the output for the third matrix. Also at 704, multiplexer 680 selects blocks 676 and 678 to output the resultant of the VMM for the fourth matrix. Input buffer 650 and, in some embodiments, output buffer 670 may be cleared.

Thus, using method 700 time multiplexing may be performed for a CIM hardware module. Thus, the benefits of compute tile 150, compute engine 100, CIM hardware modules 130, 200, 500, and 600 may be achieved. For example, increased utilization of the CIM hardware module may be attained.

FIG. 8 is a flow chart depicting an embodiment of a method for using a CIM hardware module for performing operations using time multiplexing. Method 800 is usable with CIM hardware modules 130, 200, 500, and/or 600 and other compute engines and/or compute tiles. Although particular processes are shown in an order, the processes may be performed in another order, including in parallel. Further, processes may have substeps.

Weights for the matrices are stored in blocks of a CIM hardware module at 802. In some embodiments, how the weights are stored is determined based upon desired utilization of the CIM module, throughput, latency, and/or other factors. For example, an optimization for the desired layers of the model (i.e. the desired matrices of weights) is performed. The optimization may take into account the size and utilization of the CIM hardware modules. For example, it may be desirable to be capable of storing more weights in a weight-stationary configuration. This may reduce the amount of time spent loading weights during operation of the device. Loading weights, particularly if the loading is from off-tile memory, may be time consuming. Throughput and latency may also be part of the optimization. Because time multiplexing of the VMMs performs multiple sets of VMMs, the time taken to perform these operations may be increased. Thus, latency, throughput, and/or other measures of efficiency may be accounted for in the optimization. This may improve pipelining of the model. Thus, the optimization may indicate how the weights are to be mapped to one or more CIM hardware modules, whether some or all of the weights for a particular layer are to be duplicated (e.g. in different CIM hardware modules), the schedule for the VMMs, and estimated throughput, utilization, and latency for the CIM hardware modules. Based on this and/or other techniques, the weights are stored at 802.

At 804 the VMMs for the matrices of weights are calculated using time multiplexing and the configuration of weights stored at 802. For example, method 700 may be used to perform VMMs of blocks of the CIM hardware module.

Thus, using method 800 time multiplexing may be performed for a CIM hardware module. Thus, the benefits of compute tile 150, compute engine 100, CIM hardware modules 130, 200, 500, and 600 may be achieved. For example, increased utilization of the CIM hardware module may be attained.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A hardware compute-in-memory (CIM) module, comprising:
storage sites; and
compute logic coupled with the storage sites for performing, in parallel, operations on data stored in the storage sites;
wherein the CIM hardware module is configured to store weights in blocks of the storage sites, to utilize the blocks and portions of the compute logic corresponding to the blocks to selectively provide outputs of the operations for the weights stored in the blocks, and to read the outputs of the operations corresponding to the blocks at different times.

2. The CIM hardware module of claim 1, wherein to utilize the blocks and the portions of the compute logic the CIM hardware module is configured to route an input to a portion of the compute logic for a block of the blocks.

3. The CIM hardware module of claim 2, wherein to read the outputs the CIM hardware module reads an output corresponding to the block.

4. The CIM hardware module of claim 3, wherein the CIM hardware module further includes:
a demultiplexer configured for routing the input to the portion of the compute logic for the block; and
a multiplexer configured to select the output corresponding to the block.

5. The CIM hardware module of claim 1, wherein the blocks include a first block and a second block, the weights of the first block being replicated in the weights of the second block.

6. The CIM hardware module of claim 1, wherein the hardware CIM is configured to store the weights in the blocks based on an optimization of throughput and utilization of the CIM hardware module.

7. The CIM hardware module of claim 1, wherein the operations comprise vector-matrix multiplication operations.

8. The CIM hardware module of claim 1, wherein the blocks include a first block and a second block, the first block and the second block sharing a portion of the compute logic, a first output of the operations on the first block being output at a first time, and a second output of the operations for the second block being output at a second time.

9. The CIM hardware module of claim 8, wherein the compute logic includes a first plurality of logic gates corresponding to the first block, a second plurality of logic gates corresponding to the second block, and adders coupled to the first plurality of logic gates and the second plurality of logic gates, the adders providing a first output at the first time and the second output at the second time.

10. The CIM hardware module of claim 8, wherein the second block is not powered on during the first time and the first block is not powered on during the second time.

11. A compute tile, comprising:
a plurality of compute engines, each of the plurality of compute engines including a hardware compute-in-memory (CIM) module, the CIM hardware module including a plurality of storage sites and compute logic coupled with the plurality of storage sites for performing, in parallel, operations on data stored in the storage sites; and
a general-purpose (GP) processor coupled with the plurality of compute engines and configured to provide control instructions and data to the plurality of compute engines;
wherein the CIM hardware module is configured to store weights in blocks of the storage sites, to utilize the blocks and portions of the compute logic corresponding to the blocks to selectively provide outputs of the operations for the weights stored in the blocks, and to read the outputs of the operations corresponding to the blocks at different times.

12. The compute tile of claim 11, wherein the CIM hardware module further includes:
a demultiplexer configured for routing an input to a portion of the compute logic corresponding to a block of the blocks; and
a multiplexer configured to select an output corresponding to the block.

13. The compute tile of claim 11, wherein the hardware CIM is configured to store the weights in the blocks based on an optimization of throughput and utilization of the CIM hardware module.

14. The compute tile of claim 11, wherein the operations comprise vector-matrix multiplication operations.

15. The compute tile of claim 11, wherein the blocks include a first block and a second block, the first block and the second block sharing a portion of the compute logic, a first output of the operations on the first block being output at a first time, and a second output of the operations for the second block being output at a second time.

16. The compute tile of claim 15, wherein the compute logic includes a first plurality of logic gates corresponding to the first block, a second plurality of logic gates corresponding to the second block, and adders coupled to the first plurality of logic gates and the second plurality of logic gates, the adders providing a first output at the first time and the second output at the second time.

17. A method, comprising:
performing in parallel a first plurality of operations on a first set of weights stored in a first block of a plurality of blocks of storage sites of a hardware compute-in-memory (CIM) module, the CIM hardware module including compute logic coupled with the storage sites, the compute logic configured to selectively perform in parallel, operations for the plurality of blocks and provide outputs for the operations, the operations including the first plurality of operations;
outputting, from the CIM hardware module, a first output for the first plurality of operations corresponding to the first block at a first time;
performing in parallel a second plurality of operations on a second set of weights stored in a second block of the plurality of blocks, the operations including the second plurality of operations; and
outputting, from the CIM hardware module, a second output for the second plurality of operations corresponding to the second block at a second time.

18. The method of claim 17, further comprising:
storing, in the first block and the second block, the first set of weights and the second set of weights.

19. The method of claim 18, wherein the storing further includes:
storing of the first set of weights and the second set of weights in the first block and the second block based on an optimization of throughput and utilization of the CIM hardware module.

20. The method of claim 17, wherein the performing in parallel the first plurality of operations further includes:
routing a first input to a first portion of the compute logic for the first block; wherein the reading the first output further includes:
using a multiplexer to select the first output corresponding to the first block; wherein the performing in parallel the second plurality of operations further includes routing a second input to a second portion of the compute logic for the second block; and
wherein the reading the second output further includes using a multiplexer to select the second output corresponding to the second block.
